(19) United States
(12) Patent Application Publication
(10) Pub. No.: US 2025/0185691 A1
(43) Pub. Date: Jun. 12, 2025

(54) METHOD FOR PROVIDING A DRIED HYDROLYSED MATERIAL

(71) Applicant: Haarslev Industries A/S, Søndersø (DK)

(72) Inventors: Henning HAUGAARD, Vamdrup (DK); Josep CLOSA, La Garriga (ES)

(21) Appl. No.: 18/842,904

(22) PCT Filed: Feb. 27, 2023
(86) PCT No.: PCT/EP2023/054872

§ 371 Date: Aug. 30, 2024

(30) Foreign Application Priority Data
Mar. 1, 2022 (DK) PA 2022 00158

(51) Int. Cl. A23J 3/30; A23J 1/10; A23J 3/04; A23K 10/26; A23K 20/147

(52) U.S. Cl. CPC A23J 3/30; A23J 1/10; A23J 3/04; A23K 10/26; A23K 20/147

(57) ABSTRACT

The present invention relates to a method for providing a dry highly digestible material from a starting material, the method comprising hydrolysing the starting material, providing a hydrolysed material; subjecting the hydrolysed material to a fat removal process, providing a fat-reduced material; and subjecting the fat-reduced material to an air drying process resulting in a dried highly digestible material. hydrolysed material to a drying process resulting in a dried highly digestible material.

### TECHNICAL FIELD OF THE INVENTION

The present invention relates to a method for providing a dried hydrolysed material. In particular the present invention relates to an improved method for providing highly digestible hydrolysed material, preferably from a keratinaceous material, preferably feathers.

### BACKGROUND OF THE INVENTION

The worldwide demand for high quality proteins for human food and animal feed is continuously increasing, one reason being the increasing human population, the increasing demand for human food and meat leads to an increasing animal population that need feed.

Plant based protein sources, like soybean meal or corn, have traditionally been the main protein source in the feeds for ruminants. Other plant-origin sources, fishmeal and meal prepared from keratinaceous material, like feathers, are used to a certain extent.

The price of plant-based protein sources are increasing, and with the growth of the animal sector due to global population growth and increased per capital global consumption of meat, plant-based proteins fails to meet the increasing demand.

The supply of non-genetically modified soybeans is diminishing, which creates uncertainty for the consumers. The obvious negative impact of expansion of soybean cultivation is the loss of the natural ecosystems of tropical forest. From those reasons, there is a need to find and incorporate alternative protein sources.

Together with plant-based proteins and in order to meet the demand for high quality protein sources, preferably without the negative effects of plant protein sources, like increased fibre content and presence of anti-nutritional factors, fish meal, bone meal, and meal prepared from keratinaceous material, like feathers, has gained increasing attention.

Processes of producing feather meal are already described and EP 3 402 340 A1 describes a method for producing feather meal. EP 3 402 340 A1 where feathers are subjected to hydrolysis in a continuous vertical hydrolyser, working at 7 bar and saturated steam, feathers from chicken with a moisture content of 65% (w/w) were treated for 25 min. The hydrolysed keratinaceous material was brought to atmospheric pressure through a let-down valve, and the fibrous mass contained about 55% (w/w) water, while being at a temperature of 95° C. The hydrolysed feather was split in two portions and one portion was sent directly to spin flash drying and the second portion was pressed in a screw press to remove water and residual water in the hydrolysed feathers was about 45% (w/w) before the material was sent directly to spin flash drying. The resulting dry feather meal had a moisture content of 7% (w/w) and a pepsin digestibility of 85%.

The challenge with the processes described is that do not consider the impact of fat from the starting material on the process and in particular on the effectivity and productivity of the spin flash dryer as well as the desire in the industry to have low fat products.

A further challenge with the presently available methods is that the presently available spin flash dryers may be limited by the production capacity. The production capacity (capacity) may be challenged by the physical dimensions and/or the energy consumption of the dryer.

Thus, the capacity of the spin flash drying process is limited because of the physical dimensions of the spin flash dryer, and the energy consumption because of excessive amounts of process energy and process air necessary to remove the large amounts of water in the hydrolysed material.

These challenges makes the method ineffective, complex, uneconomic, an undesirable investment and/or an un-necessary burden on the environment.

Hence, there is a need for an improved method and a system solving the above challenges would be advantageous. In particular, a method and a system being more efficient, reliable, cost effective, simple and environmental-friendly would be advantageous.

### SUMMARY OF THE INVENTION

Thus, an object of the present invention relates to an improved method for providing highly digestible hydrolysed material, preferably from a keratinaceous material, in particular feathers.

In particular, it is an object of the present invention to provide a method and a system that solves the above-mentioned problems of the prior art with effectivity, capacity, safety, productivity, reproducibility, dimensions, complexity, economy/investment and the environment.

Thus, an aspect of the present invention relates to a method for providing a dry highly digestible material from a starting material, the method comprising:
hydrolysing the starting material, providing a hydrolysed material;
subjecting the hydrolysed material to a fat removal process, providing a fat-reduced material; and
subjecting the fat-reduced material to an air drying process resulting in a dried highly digestible material.

A further aspect of the invention relates to a method for providing a dry highly digestible material from a starting material, the method comprising:
hydrolysing the starting material, providing a hydrolysed material;
subjecting the hydrolysed material to a pre-treatment where water in the hydrolysed material may be at least vapourised resulting in a pre-dried hydrolysed material, wherein the pre-dried hydrolysed material may have a moisture content in the range of 15-50% (w/w) water; and
subjecting the pre-dried hydrolysed material to a drying process resulting in a dried highly digestible material

wherein the hydrolysed material may be subjected to a fat-removal process and/or wherein the pre-dried hydrolysed material may be subjected to a fat-removal process.

Another aspect of the present invention relates to a dried highly digestible material obtained by the method according to the present invention.

A further aspect of the present invention relates to a highly digestible hydrolysed keratinaceous material having a digestibility of 87% or higher.

An even further aspect of the present invention relates to a dried highly digestible material comprising a crude protein content in the range of 80-97% (w/w), and a fat content in the range of 0.01-8% (w/w), below 10% (w/w) water.

Yet another aspect of the present invention relates to a system comprising a hydrolyser in fluid connection to a contact dryer which contact dryer may be in fluid connection with an air dryer, in particular a spin flash dryer.

A further aspect of the present invention relates to a system comprising a hydrolyser in fluid connection to an oil or fat removing device, such as a press, a decanter (preferably a decanter), which oil or fat removing device is in fluid connection to a contact dryer, such as a disc dryer, which contact dryer is in fluid connection with an air dryer, such as a spin flash dryer.

Still another aspect of the present invention relates to the use of a pre-drying process followed by an air-drying process, in particular a spin flash drying process, of a hydrolysed material for providing a dried highly digestible material, preferably the dried highly digestible material comprises a pepsin digestibility higher than 75%.

### BRIEF DESCRIPTION OF THE FIGURES

FIG. 1 shows a process according to the prior art where hydrolysed material, such as feather meal, are transferred directly from the hydrolyser to the drying using a spin flash dryer;

FIG. 2 also shows a process according to the prior art where hydrolysed material, such as hydrolysed feather meal, subjected to pressing for reducing the water content whereby the press cake is transferred directly from the screw press to a spin flash dryer, and

FIG. 3 shows a process according to the present invention where hydrolysed material, such as hydrolysed feather meal, is subjected to a pre-drying treatment in a disc dryer for reducing the water content whereby the pre-dried material is subsequently transferred to a spin flash dryer for performing the final drying.

The present invention will now be described in more detail in the following.

### DETAILED DESCRIPTION OF THE INVENTION

Accordingly, the inventors of the present invention surprisingly found that the combination of a pre-drying process (using contact drying e.g. using disc drying) and the drying process (using air drying, e.g. using spin flash drying) may provide a significant reduction in the air flow, the energy necessary for drying the product and thus, are more gentle to the environment.

The inventor of the present invention also found a great challenge with air drying of feather meal, since the starting material often has a quality with a significant amount of fat included. When taken such starting material after hydrolysis into the air dryer, in particular the spin flash dryer, the fat and oil in the hydrolysed material may be thrown around in the drying chamber and greases the interior of the drying chamber and the rotor, the inlets, the outlets, the walls, etc. are plastered and clogged with fat/oil and the layer becomes thicker and thicker over time. Accordingly, the inventors of the present invention surprisingly found that by removing the fat/oil, or part of the fat/oil, from the material before entering the air dryer these disadvantages may be avoided or significantly reduced.

Advantageously, the fat may be removed from the starting material after the hydrolysis as the hydrolysing process may assist in liberation of fat from the solid material, and removal may be easier.

A preferred embodiment of the present invention relates to a method for providing a dry highly digestible material from a starting material, the method comprising:
hydrolysing the starting material, providing a hydrolysed material;
subjecting the hydrolysed material to a fat removal process, providing a fat-reduced material; and
subjecting the fat-reduced material to an air drying process resulting in a dried highly digestible material.

The hydrolysed material or the fat-reduced material may be subjected to a pre-treatment where water, or at least part of the water, in the hydrolysed material may be at least vapourised resulting in a pre-dried hydrolysed material.

Preferably, the pre-dried hydrolysed material may have a moisture content in the range of 15-50% (w/w) water.

The inventors also found that the digestibility of the method and the system according to the present invention resulted in a dry highly digestible material, in particular feather meal, having a digestibility higher than other products described. Without being bound by theory, it is believed that the increase in digestibility is provided by two factors, the first being that stick water may be maintained in the hydrolysed material along the method without being removed or the stick water may be recycled to the press cake with a reduced amount of fat, or introduced into the air dryer together with the press cake. The second factor considered improving the digestibility may be the combination of a pre-drying process, (e.g. using a contact dryer, such as using a disc dryer), followed by a drying process, (e.g. using an air dryer, such as a spin flash dryer).

A preferred embodiment of the present invention relates to a method for providing a dry highly digestible material from a starting material, the method comprising:
hydrolysing the starting material, providing a hydrolysed material;
subjecting the hydrolysed material to a pre-treatment where water in the hydrolysed material is at least vapourised resulting in a pre-dried hydrolysed material, wherein the pre-dried hydrolysed material has a moisture content in the range of 15-50% (w/w) water; and
subjecting the pre-dried hydrolysed material to a drying process resulting in a dried highly digestible material

wherein the hydrolysed material is subjected to a fat-removal process and/or wherein the pre-dried hydrolysed material is subjected to a fat-removal process.

Preferably, the drying process for drying the pre-dried hydrolysed material may be a different drying process than used in the pre-treatment.

In an embodiment of the present invention the drying process for drying the pre-dried hydrolysed material may be an air-drying process.

Preferably, the air dryer (performing the air-drying process) may be performed by using a flow of hot air, such as in a spin flash dryer, a flash dryer, a fluidized bed dryer, a ring-type dryer, a rotating flash dryers or the like. Preferably, the drying process for drying the pre-dried hydrolysed material may be a spin flash drying process. The spin flash dryer may be an addition to spin flash dryers referred to as air-turbulence mills; turbulent air grinding mills; vortex air mills; spin driers and grinders; flash dryers and grinders. All these are basically characterised by drying and milling the pre-dried hydrolysed material in a short period of time.

In an embodiment of the present invention the drying process for drying the pre-dried hydrolysed material may be a spin flash drying process.

The starting material may be selected from a keratinaceous material.

The keratinaceous material used in the present invention preferably comprises feathers, hair, wool, hooves or nails. Feathers may be by-products from poultry (chicken, turkey, duck and the like), and hair and wool may be a by-product from pigs, cattle, sheep and the like. Hooves or nails may originate from a variety of animal sources and may be used in ground form as a source of keratinaceous material.

In a preferred embodiment, feathers are used as keratinaceous material as the starting material of the present invention.

Advantageously, keratinaceous material produced in accordance with a method of the present invention may provide a valuable source of protein and/or source of amino acids in animal feed. For example, keratinaceous material can provide a source of one or more of the following amino acids: methionine, cysteine, lysine, threonine, arginine, isoleucine, leucine, valine, histidine, phenylalanine, glycine, serine, proline, alanine, aspartic acid, tyrosine, tryptophan and glutamic acid.

The keratinaceous material for use in the present invention may preferably have a high protein content (generally more than 70% (w/w) of the dry substance), comprising at least 17 amino acids. The protein content normally is determined by measuring the total amount of nitrogen, and multiplying said total nitrogen content with the so-called Jones factor of 6.25. The result is the theoretical amount of protein. Generally, feathers comprise between 70-90% (w/w) protein on solids; the amount of solids in raw feathers collected from a slaughterhouse generally is about 30% (w/w). Feather meal generally contains about 72 to about 87% (w/w) protein, assuming less than 8% (w/w) moisture.

In an embodiment of the present invention the starting material may comprise a fat content of 1% (w/w) or higher, such as a fat content of 2% (w/w) or higher, e.g. a fat content of 3% (w/w) or higher, such as a fat content of 4% (w/w) or higher, e.g. a fat content of 5% (w/w) or higher, such as a fat content of 6% (w/w) or higher, e.g. a fat content of 7% (w/w) or higher, such as a fat content of 8% (w/w) or higher, e.g. a fat content of 9% (w/w) or higher, such as a fat content of 10% (w/w) or higher, e.g. a fat content of 12% (w/w) or higher, such as a fat content in the range of 1-12% (w/w), e.g. a fat content in the range of 3-10% (w/w), such as a fat content in the range of 5-8% (w/w), e.g. a fat content in the range of 6.5-7.5% (w/w).

In a further embodiment of the present invention the starting material may comprise a fat content, on a dry matter basis of the starting material (relative to the sum of the solid content and the fat content) in the range of 5-25% (w/w), e.g. in the range of 10-23% (w/w), such as in the range of 15-22% (w/w), e.g. in the range of 17-21% (w/w), such as about 20% (w/w).

In the present context the term “about” relates to plus or minus 20% of the value in question, such as plus or minus 10%, e.g. plus or minus 5%, such as plus or minus 2%.

In an embodiment of the invention blood of slaughtered animals may also be processed together with the keratinaceous material.

Preferably, the blood product may be mixed with the raw feathers, or other keratinaceous material, before the hydrolysing step and the combined product may be hydrolysed and dried according to the process of the present invention to obtain meal suitable dried highly digestible material, e.g. for use as food or feed product.

In an embodiment of the present invention, blood and keratinaceous material, in particular feathers, may be introduced into the hydrolyser via separate inlets, and mixed and hydrolysed in the hydrolyser.

In a further embodiment of the present invention clotted blood may be combined with hydrolysed keratinaceous material, e.g. hydrolysed feathers, before entering the air dryer.

In such an embodiment of the invention, the raw full blood may first be coagulated by direct contact and mixing with steam and further centrifuged to remove mechanically the blood water from the coagulated blood. The coagulated blood commonly referred to as “blood clot” can be mixed together with the hydrolysed feathers coming out of the hydrolyser and subsequently dried as a mixture in the air dryer.

Hydrolysis may be a chemical reaction in which a molecule of water is added to a substance by breaking chemical bonds in compounds, such as the proteins in the substance. This addition may cause both the compounds in the substance and water molecule to split into several parts. In such reactions, one fragment of the target molecule (the substance) gains a hydrogen ion. It breaks a chemical bond in the compound.

Given the wide differences in the chemical and physical properties of samples, compounds, proteins and amino acids, different hydrolysis procedures are known to the skilled person. The different hydrolysis procedures may vary by the type of reaction (chemical or enzymatic), the nature of the chemical reaction (acid or base), and the physical state of the reaction (liquid or vapor). The differences in the hydrolysis procedures may impact the recovery of specific peptides and amino acids-which may be destroyed by specific reagents—or the efficiency and time required for the hydrolysis.

In an embodiment of the present invention the hydrolysing process of the present invention may be selected from a thermal hydrolysis (hydrothermal hydrolysis), a chemical hydrolysis using acidic or alkaline conditions, or an enzymatic hydrolysis.

Depending on the application of the product to be hydrolysed, some reagents are undesirable either during the process, for the environment or for the application of the resulting hydrolysed product. If such reagents are used, they need to be removed from the hydrolysed product, adding costs to the process and potentially compromising the yield of the resulting hydrolyses product and requires a more complex process.

Preferably, the hydrolysing process of the present invention may be a thermal hydrolysis.

The resulting hydrolysed product may preferably be a highly digestible hydrolysed product, preferably with improved nutritional value for feed applications.

In an embodiment of the present invention the hydrolysing process of the present invention may adjusted to provide a hydrolysed product.

When the starting material may be a keratinaceous material the hydrolysing process may be a hydrolysis of the keratinaceous material.

In an embodiment of the present invention the hydrolysis of the keratinaceous material of the process of the invention, may in a preferred process involve the following:
(a) loading of a continuous or discontinuous vertical or horizontal hydrolyser with raw feathers or other keratinaceous material, optionally with raw blood. The raw feathers may have a moisture content between 55% and 70%. This moisture content may mainly come from the slaughterhouse as the birds are scalded in hot water before plucking. Plucked feathers are then conveyed in water to a centrifuge or press before discharge in the receiving bin; and/or
(b) heating up of the hydrolyser. The heating may preferably be done using steam. The steam may be injected into a steam jacket surrounding the reaction chamber or by introducing hot oil coils inside the reaction chamber (providing in-direct heating of the keratinaceous material), or the steam may be injected directly into the reaction chamber (providing direct heating of the keratinaceous material); and/or
(c) increasing the pressure inside the reaction chamber. The increased pressure may be provided mechanically or by build-up due to water evaporation and/or direct steam injection into the reaction chamber, or a combination of mechanical pressure and water/steam. Preferably, the pressure in the reaction chamber during hydrolyses may be increased (and maintained) at a pressure in the range of about 2 bar to about 100 bar, preferably between about 3 and about 50 bar, and more preferably between 4 to 25 bars, more preferably between about 5 and about 15 bar, and more preferably between 6 to 10 bars. The pressure is given as bar absolute; and/or
(d) maintaining the starting material to a temperature during the hydrolysis process in the range of 100-300° C., such as in the range of 125-225° C., e.g. in the range of 150-200° C., such as in the range of 160-180° C., e.g. about 170° C.; and/or
(e) continuing the hydrolysing process may be in the range of 30 seconds up to 240 min, preferably in the range of 2 seconds up to 30 min, more preferably in the range of 5 min to 40 min and most preferably in the range of 10 to 30 min. A lower pressure may generally require a longer treatment time, while high pressures may require shorter treatment times to obtain a suitable hydrolysis; and/or
(f) depressurizing and discharging the hydrolysed material. Because of the change from high pressure to low pressure (atmospheric pressure) when depressurizing and discharging the hydrolysed material an amount of the moisture present in the hydrolysed material may evaporate—of flash off—causing a reduction in the moisture content of the hydrolysed material when doing from high pressure conditions to conditions with low pressure conditions (at substantial equal temperatures).

The raw keratinaceous material may be milled or crushed to reduce the size before loading in the hydrolyser to improve hydrolysis.

The wet keratinaceous material may generally have a moisture content in the range of about 30 and about 80% (w/w) (% moisture relative to the total weight of the keratinaceous material plus moisture) when supplied to the hydrolyser according to the present invention, such as in the range of 40-75% (w/w), e.g. in the range of 50-70% (w/w), such as in the range of 57-67% (w/w), e.g. in the range of 60-65% (w/w).

Since the water present in the starting material, e.g. the wet keratinaceous material, or added during the process need to be removed, it is preferred to keep the moisture content of the wet keratinaceous material as low as possible.

Removal of water from the following hydrolysed material may be crucial for the resulting dried highly digestible product since the water removal may have significant influence on productivity, yield of dried highly digestible product, digestibility of the dried highly digestible product, and the cost of the process, because removal of water requires a lot of energy, heat, air flow and handling.

The hydrothermal hydrolysis reaction may be breaking up peptide bonds of the keratinaceous material by the action of water, temperature and pressure. Generally, no acid or base may be present, although some may be present in the keratinaceous material coming from the slaughterhouse. Generally small amounts of added reagents are possible to use such as calcium hydroxide or high temperature resistant enzymes.

It is preferred that the hydrolysing process may be a hydrothermal hydrolysing process only using water/steam as the active reagent.

In an embodiment of the present invention the hydrolysed material provided may have a moisture content of 40% (w/w) water or higher, such as 45% (w/w) water or higher, e.g. 50% (w/w) water or higher, such as 55% (w/w) water or higher, e.g. in the range of 40-65% (w/w) water, such as in the range of 43-55% (w/w) water, e.g. in the range of 45-52% (w/w) water, such as about 50% (w/w) water.

The hydrolysis may be performed in a hydrolyser. The hydrolyser according to the present invention may be operated as a batch process or as a continuous process. Preferably the hydrolyser may be operated as a continuous process.

The hydrolyser may preferably be a horizontal hydrolyser or a vertical hydrolyser. Preferably, the hydrolyser may be a horizontal hydrolyser.

The pressure and the temperature may be set to provide saturated steam, optionally in combination with water inside the reaction chamber of the hydrolyser. Preferably, the amount of steam added to the reaction chamber is in the range of 100-300 gram steam per kg of keratinaceous material, such as in the range of 150-250 gram steam per kg of keratinaceous material, e.g. in the range of 175-225 gram steam per kg of keratinaceous material, such as about 200 gram steam per kg of keratinaceous material.

One of the challenges with the processes presently described may be that the moisture content of the hydrolysed material entering the spin flash dryer may be very high, even some water may be removed by pressing before entering the air dryer, whereby the capacity of spin flash dryer may compromise the productivity, costs and/or even the of the resulting dried highly digestible material, alternatively the physical dimensions of the spin flash dryer should be adjusted, resulting in uneconomical and uninteresting constructions and operational costs, which may also compromise the quality of the resulting dried highly digestible material.

In an embodiment of the present invention pre-treatment according to the present invention may include the combination of pressing of the hydrolysed material followed by evaporation of water, e.g. by drying, e.g. in a contact dryer, e.g. in a disc dryer, resulting in a pre-dried hydrolysed material, wherein the pre-dried hydrolysed material may have a moisture content in the range of 15-50% (w/w) water.

The pressing may be performed in a screw press or a twin-screw press. The press may be used for introducing a pre-dewatering process, for reducing the water content of the hydrolysed material, before the hydrolysed material, may be subjected to pre-treatment, (e.g. by a contact dryer—such as a disc dryer.

In an embodiment of the present invention the hydrolysed material may be subjected to a fat removal step, providing a fat-reduced material.

In the present context the term “fat” may be a fat and/or an oil.

In a further embodiment of present invention, the fat removal step may be performed after pressing of the hydrolysed material, providing a fat-reduced material.

The hydrolysed material may be subjected to liquid separation, e.g. by pressing resulting in a press liquid and a press cake. In an embodiment of the present invention the press liquid may be subjected to a step of fat removal. In a further embodiment of the present invention the press cake may be subjected to a step of fat removal. In a further embodiment of the present invention the press liquid and the press cake may be subjected to a step of fat removal.

In yet an embodiment of the present invention the fat removal step may be performed before subjecting the material to an air drying resulting in a dried highly digestible material having a reduced content of fat.

As such keratinaceous material does not comprise blood or fat/oils, however, before loading the raw keratinaceous material into the hydrolyser, the keratinaceous material may have been removed from the animal. When removing e.g. feathers from poultry, like chicken, the chicken is killed, and scalded for a short period of time to loosen the feathers from the chicken body. After the scalding the feathers are removed from the chicken by a suitable machine that rips of the feathers. During this process fat from the chicken are extracted into the water during scalding, body parts and heads of the chicken are ripped off by the machine removing feathers and ends up with the feathers and may contribute to a significant amount of fat in the feathers starting material and in the feather meal.

In particular fat may be undesirable for both a nutritional perspective of the feather meal, but also in respect of the processing conditions that may be limited, where the inventors found that the air dryer may be intensively greased at the interior of the drying chamber as the fat may act like butter that melts and may be sprayed around the drying chamber of the air dryer and plaster to and accumulate on the inside walls. This wil eventually block the dryer as well as the inlet flow may be blocked due to clogging of the nozzles and decreased output capacity.

Thus, excessive amount of fat in the feather fraction may cause impeding of air flow, impeded milling, cause an increased energy consumption and resulting in a product with reduced nutritional value, a process of decreased output capacity and a process with low productivity, due to the amount of fat present in the starting material. Moreover, the accumulation of fat inside the drying chamber may also increase the risk of the accumulated material to start a fire and pose a security risk.

Hence, the inventors of the present invention found that measures may be taken to remove the fat, or at least part of the fat, from the starting material, such as the keratinaceous material, before drying in an air-dryer, to provide a more stable, safer and reproducible process, and to provide a process with higher productivity, higher output capacity and higher nutritional value.

In an embodiment of the present invention the fat or oil content in the pre-dried hydrolysed material and/or in the dried highly digestible material may be below 10% (w/w), such as below 8% (w/w), e.g. below 7% (w/w), such as below 6% (w/w), e.g. below 5% (w/w), such as below 4% (w/w), e.g. below 3% (w/w), such as below 2% (w/w), e.g. below 1% (w/w), such as in the range of 0.01-10% (w/w), e.g. in the range of 0.05-9% (w/w), such as in the range of 0.1-8% (w/w), e.g. in the range of 0.5-7.5% (w/w), such as in the range of 0.75-7% (w/w), e.g. in the range of 1-6% (w/w), such as in the range of 1.25-5% (w/w), e.g. in the range of 1.5-4% (w/w), such as in the range of 1.75-3% (w/w), e.g. in the range of 2-2.5% (w/w).

It may be preferred that the fat content of the dried highly digestible material may be at least 15% lower than the fat content of the starting material, more preferably at least 20%, even more preferably at least 25%, even more preferably at least 30%, even more preferably at least 35%, even more preferably at least 40%, even more preferably at least 45%, even more preferably at least 50%, even more preferably at least 55%, even more preferably at least 60%, even more preferably at least 65%, even more preferably at least 70%, even more preferably at least 75%, even more preferably at least 80%, even more preferably at least 85%, even more preferably at least 90%.

The method according to the present invention involves a step of subjecting the hydrolysed material to a pre-treatment where water in the hydrolysed material may be at least partly vapourised resulting in a pre-dried hydrolysed material.

Preferably, the pre-dried hydrolysed material may have a moisture content in the range of 15-50% (w/w) water.

The pre-treatment of the hydrolysed material performed, may be performed in a dryer or an evaporator, under conditions resulting in a pre-dried hydrolysed material, wherein the pre-dried hydrolysed material has a moisture content in the range of 15-50% (w/w) water.

In an embodiment of the present invention the pre-dried hydrolysed material obtained may have a moisture content in the range of 15-50% (w/w) water, such as in the range of 20-45% (w/w), e.g. in the range of 25-43% (w/w), such as in the range of 30-40% (w/w), e.g. in the range of 32-38% (w/w), such as about 35% (w/w).

In yet an embodiment of the present invention the pre-dried hydrolysed material obtained may have a moisture content in the range of 15-35% (w/w) water, such as in the range of 18-30% (w/w), e.g. in the range of 20-25% (w/w), such as about 22% (w/w).

Preferably, the pre-treatment of the hydrolysed material, may be performed in a dryer, resulting in a pre-drying of the hydrolysed material.

In an embodiment of the present invention the pre-treatment may include a drying step, including a contact dryer. Preferably, the contact dryer may be a steam contact dryer.

In an embodiment of the present invention the pre-drying may be performed at temperatures below 100° C.; more preferably, at temperatures below 90° C.; even more preferably at temperatures below 80° C.; even more preferably at temperatures below 75° C.

Pre-drying may preferably be performed at reduced pressure to keep the temperature during the pre-drying low.

In an embodiment of the present invention the pre-treatment of the hydrolysed material may be a pre-drying of the hydrolysed material.

Various driers may be used for the pre-drying. Preferred dryers are those that gently removes water from the hydrolysed material. Furthermore, dryers capable of running with large volumes may be preferred.

In an embodiment of the present invention the pre-drying may include a dryer that gently removes water from the hydrolysed material and that is capable of running with large volumes may be preferred.

Preferable the pre-drying of the hydrolysed material may be performed in a dryer at a temperature/time/pressure combination which limits the drop in pepsin and/or ileal digestibility by less than 10%, and/or such that the pepsin digestibility may be higher than 75%.

Gentle removal of water may include removal of water under conditions (in particular time, temperature and pressure) where the drop in digestibility during the pre-drying is less than 10%, such as less than 8%, e.g. less than 6%, such as less than 4%, e.g. less than 2%, such as less than 1%, e.g. less than 0.1%.

In an embodiment of the present invention the pepsin digestibility of the pre-treated and/or the pre-dried hydrolysed material may be higher than 75%, such as higher than 80%, e.g. higher than 85%, such as 86% or higher, e.g. 87% or higher, such as 88% or higher, e.g. 89% or higher, such as 90% or higher, e.g. 91% or higher, such as 92% or higher, e.g. 93% or higher.

Dryers capable of running with large capacities may include a disc dryer, a drum dryer, a coil dryer, a condi dryer, or a hot air dryer. Hot air dryers may include a ring dryer, a fluidized bed dryer

Preferably, the dryer used for pre-drying may be steam dryer or contact dryer, such as a disc dryer, a coil dryer, a condi dryer, rotor tube dryer, or a paddle dryer. Even more preferably, the dryer used for pre-drying may be a disc dryer, or a condi dryer. Even more preferably, the dryer used for pre-drying may be a disc dryer. Even more preferably, the dryer used for pre-drying may be a vacuum disc dryer. Even vacuum disc dryers have shown to be suitable for dying feather meal, and may be used in the pre-drying, vacuum disc dryers maybe impose unnecessary costs to the process since the pre-drying does not perform a full drying of the hydrolysed material and then the influence of the increased temperature on the resulting dried hydrolysed digestible material, may be considered insignificant.

The pre-dried hydrolysed material obtained from the pre-treatment may be subjected to a drying process resulting in a dried highly digestible material.

Drying of is an important step for the final quality of the dried highly digestible material, e.g. a keratinaceous material, such as feather meal.

In a preferred embodiment of the present invention, the pre-dried hydrolysed material resulting from the pre-treatment or the fat reduced material may be dried with a method allowing low heat damage, such that the reduction of the digestibility of the keratinaceous material is limited and characterized by a pepsin remains high and that a reduction in pepsin digestibility measured before and after the drying step is low, preferably less than 10%, even more preferably less than 5%.

To obtain such material with low heat damage, the drying may preferably be carried out with a gas flow, preferably the gas flow may be air. In an embodiment of the present invention the drying process of the pre-dried hydrolysed material or the fat reduced material may be an air-drying process.

In an embodiment of the present invention the pre-dried hydrolysed material or the fat reduced material, may, at the same time, or substantially at the same time, as being dried, be subjected to milling of the pre-dried hydrolysed material or of the fat reduced material.

This, simultaneous, or substantially simultaneous, drying and milling may provide further improvement of the in vitro digestibility and material characteristics of the dried highly digestible material, because the small particles that result from the milling action assist in quickly drying the pre-dried hydrolysed material.

Thus, the drying process (for drying the pre-dried hydrolysed material or the fat reduced material) according to the present invention may provide a reliable milling and gas (preferably air) drying system that enables maintaining the integrity of the high-value protein chains in the hydrolysed material and in the pre-dried hydrolysed material and in the fat reduced material.

In an embodiment of the present invention, the pre-dried hydrolysed material or the fat reduced material may be dried in the spin flash dryer to a moisture content of about 12% (w/w) or less, preferably about 8% (w/w) or less, more preferably about 6% (w/w) or less, preferably about 4% (w/w) or less. Drying to a moisture content lower than about 4% (w/w) may generally not be necessary but would not harm. Drying the pre-dried hydrolysed material or the fat reduced material to a moisture content in the range of about 1-12, such as in the range of 2-11, e.g. in the range of 3-10, such as in the range about 5-7% (w/w) may be most preferred.

In a further embodiment of the present invention the average particle size of the dried highly digestible material leaving the dryer-performing drying and milling when measured as d50 in volume fraction, as measured with laser diffraction using a dry powder Beckman Coulter particle size analyser, is between about 20 μm and about 0.7 mm and the d90 is below about 1 mm.

Various driers exist that are useful in the present invention offering combined drying and milling. Some constructions may offer simultaneous drying and milling, other constructions may offer an initial milling of the pre-dried hydrolysed material before the material is dried, and some constructions may offer an initial drying followed by milling of the dried highly digestible material.

Preferably, the pre-dried hydrolysed material or the fat reduced material may be subjected to simultaneous drying and milling, or an initial milling of the pre-dried hydrolysed material or the fat reduced material before the material may be dried. Most preferably the pre-dried hydrolysed material or the fat reduced material may be subjected to an simultaneous drying and milling.

The drying of the pre-dried hydrolysed material or the fat reduced material may have the benefit of a fast grinding and drying-effect, and may results in combined drying and milling of the pre-dried hydrolysed material or the fat reduced material by introducing the pre-dried hydrolysed material or the fat reduced material into a flow of gas, generally air, and into a high speed rotor in a confined chamber.

The dryer may comprise a chamber (stator) with appropriate inlets and outlets for product and stream(s) of gas in which a rotating member (rotor) that can rotate at high speed. The inner walls of the stator may be lined with impacting members, like corrugated sheets, in order to increase the efficiency of the grinding with additional friction and shear forces. The rotor generally is placed vertically relative to the outlet.

In a preferred embodiment of the present invention the dryer used for drying the pre-dried hydrolysed material or the fat reduced material may be providing both drying and milling. Preferably, the dryer provided for drying the pre-dried hydrolysed material or the fat reduced material may be a spin flash dryer.

Examples of different constructions of spin flash dryers and preferred for drying the pre-dried hydrolysed material or the fat reduced material of the present invention may be the spin flash dryer from Haarslev Industries, the Cell mill from Atritor, the Drymeister from Hosokawa, the Whirl flash from Larsson, The Ultra Rotor from Jackering, the Rotormill, the TurboRotor from Gorgens Mahltechnik or spin flash dryers from SPX. Other spin flash dryers may be described in e.g. EP 3 402 340 A1, U.S. Pat. No. 4,747,550, WO1995/028512 and WO2015/136070.

The air turbulence mill may comprise a classifier, which causes a separation of larger and smaller particles. The use of a classifier allows the larger particles to be returned to the grinder, while smaller particles are left through for further processing.

The drying may be performed with a stream of gas (generally air, preferably air that may be low in oxygen) into a high-speed rotor. The inlet temperature generally ranges between about 20° C. and 500° C., preferably between about 40° C. and 400° C. and even more preferably about 60° C. and 300° C., preferably between about 80° C. and 200° C. and even more preferably about 100° C. and 175° C., preferably about 150° C. The higher end of the temperature may require careful processing and/or may require lower amounts of the heated gas to be used. It would for example be possible to use the heated gas at a temperature of about 450° C. and a second gas stream at room temperature if high gas velocities are required.

The outlet temperature of the air may preferably be below 100° C., preferably below 90° C. The temperature of the inlet-gas may be lower in case the pre-dried hydrolysed material or the fat reduced material has a higher temperature.

The flow of the air generally may be about 10 m³/h per kg of fed material or lower, preferably about 8 m³/h per kg fed material or lower, preferably about 6 m³/h or less, preferably about 5 m³/h per kg fed material or less, preferably about 4 m³/h or less, preferably about 3 m³/h per kg fed material or less. Suitable, most preferred, amounts are for example between 3 and 10 m³/h per kg of fed product, such as between 4-8 m³/h per kg of fed product, e.g. between 5-6 m³/h per kg of fed product.

The gas flow may be fed into the mill directly with the feed material, or indirectly, wherein the pre-dried hydrolysed material the fat reduced material may be fed in one place, and the gas stream may be fed into the dryer separately in one or several other places.

In an embodiment of the present invention the energy used for drying the hydrolysed material may be about 95 Nm³/hour or less, such as about 90 Nm³/hour or less, e.g. about 85 Nm³/hour or less, such as about 80 Nm³/hour or less, e.g. about 75 Nm³/hour or less, such as about 70 Nm³/hour or less.

In a further embodiment of the present invention the energy used for drying the hydrolysed material may be about 0.080 Nm³/kg feed or less, such as about 0.070 Nm³/kg feed or less, e.g. about 0.060 Nm³/kg feed or less, such as about 0.055 Nm³/kg feed or less, e.g. about 0.050 Nm³/kg feed or less, such as about 0.048 Nm³/kg feed or less, e.g. about 0.046 Nm³/kg feed or less, such as about 0.044 Nm³/kg feed or less, e.g. about 0.042 Nm³/kg feed or less, such as about 0.040 Nm³/kg feed or less.

Nm³/hour may relate to “Normal Cubic Metres Per Hour” of natural gas and relates to the amount of natural gas per hour necessary for providing the energy necessary for providing the dry highly digestible material. Nm³/kg feed relates to “Normal Cubic Metres Per Kg feed” relates to the amount of natural gas per kg feed necessary for providing the energy necessary for providing the dry highly digestible material.

The rotor may rotate with a tip speed of about 10 m/s or higher, such as about 15 m/s or higher, e.g. about 20 m/s or higher, such as about 25 m/s or higher, e.g. about 30 m/s or higher, such as about 40 m/s or higher, e.g. about 50 m/s or higher, such as in the range of about 10-150 m/s, e.g. in the range of 15-75 m/s, such as in the range of about 20-50 m/s, e.g. in the range of 25-30 m/s,

The gaseous flow (preferably air) may be introduced into the dryer in different ways.

Preferably, the main gas stream may be introduced at the bottom of the dryer and the gas flow may transport the product through the dryer.

In an embodiment of the present invention the pre-dried hydrolysed material or the fat reduced material may be transported into the dryer using a screw or a pump.

To maintain a high digestibility of the pre-treated hydrolysed material or the fat reduced material the average residence time in the drying process provided may preferably be short, like less than 10 sec, preferably below 5 seconds, more preferably below 2 seconds, even more preferably below 1 second. The low average residence time of the material to dry in the mill allows efficient drying while only a relatively small increase in temperature of the keratinaceous material is observed. In case a classifier is used, the average residence time will be higher, but the time that any powder actually is in the grinder remains preferably below 10 sec, and even more preferably below 5 sec, even more preferably below 2 sec.

Preferably the temperature of the keratinaceous material coming out of the air turbulence mill is at a temperature between about 30° C. and 90° C., more preferably between about 40° C. and 80° C., even more preferably between about 45° C. and 75° C.

The dried highly digestible material leaving the drying process may be in the form of small particles. The small particles may be separated from the gas stream, preferably this separation may be done in one or more cyclones, or by means of a bag filter or combinations of both.

It may be possible to further classify the resultant powder leaving the cyclone, like for example on a horizontal sieve for screening oversized, large particles and/or for removing dust. It may also be possible to produce different grades of feather meal, with smaller and larger particle sizes.

Reject of the sieve (oversized particles and/or dust) may preferably be reintroduced in the feed for further treatment in the drying process for drying the pre-dried hydrolysed material or the fat reduced material by mixing of reject with the wet feed material (also referred to as “back mixing”) can improve the feeding operation and overall efficiency of the drying and grinding.

Preferably, classification is done over a sieve (or other classification device) with the cut off of 1 mm or lower, such as 800 μm or lower, e.g. 500 μm or lower, such as 300 μm or lower, depending on the product to be produced.

In an embodiment of the present invention the method for providing a highly digestible material does not include a press, such as a screw press, used for reducing the water content of the hydrolysed material.

The advantage of not using such a press may be that highly digestible material from the hydrolysed material may be maintained in the hydrolysed material. In this way stick water from the hydrolysed material may be maintained in the hydrolysed material increasing the digestibility. The disadvantage of avoiding the press may be an increased difficulty in removing fat from the hydrolysed material-if necessary.

In an alternative process, the press liquid obtained from pressing the hydrolysed material may be further treated, e.g. by separation (e.g. into a fat phase, a solid phase and a liquid phase), by concentrating, or extraction. Preferably, the solid phase and the liquid phase may be re-introduced into the press cake before drying, e.g. in the air dryer.

The further treated press liquid (stick water) may be subjected to fat removal, providing a fat phase that may be removed from the material before the remaining phases (the solid phase and the liquid phase) may be re-introduced into the press cake, before being subjected to drying, e.g. in the air dryer.

The fat removal (the separation of the fat phase) may include a decanter. The decanter may be a two-phase decanter or a three-phase decanter. The three-phase decanter may be a tricanter, provided by Flottweg. The three-phase decanter may provide a fat phase, a water phase and a solid phase. Preferably, the water phase and the solid phase may be re-introduced into the press cake before being subjected to drying, even more preferably, the solid phase may be re-introduced into the press cake before being subjected to drying.

A preferred embodiment of the present invention relates to a dried highly digestible material obtained by the method according to the present invention.

A further preferred embodiment of the present invention relates to a dried highly digestible material comprising a crude protein content in the range of 80-97% (w/w), and a fat content in the range of 0.01-8% (w/w), below 10% (w/w) water.

The crude protein content of the dried highly digestible material may be in the range of 80-97% (w/w), such as in the range of 82-95% (w/w), e.g. in the range of 84-93% (w/w), such as in the range of 86-92% (w/w), e.g. in the range of 88-91% (w/w).

In an embodiment of the present invention the dried highly digestible material comprises a pepsin digestibility higher than 75%, such as higher than 80%, e.g. higher than 85%, such as 86% or higher, e.g. 87% or higher, such as 88% or higher, e.g. 89% or higher, such as 90% or higher, e.g. 91% or higher, such as 92% or higher, e.g. 93% or higher and/or wherein the dried highly digestible material comprises an average particle size when measured as d50 in volume fraction, as measured with laser diffraction using a dry powder Beckman Coulter particle size analyser, between about 20 μm and about 0.7 mm and the d90 below about 1 mm.

A further embodiment of the present invention relates to a dried highly digestible material having a pepsin digestibility higher than 86% and a dry matter content of 10% (w/w) or less.

Thus, the dried highly digestible material obtained from the method according to the present invention may comprise a pepsin digestibility higher than 75%, such as higher than 80%, e.g. higher than 85%, such as 86% or higher, e.g. 87% or higher, such as 88% or higher, e.g. 89% or higher, such as 90% or higher, e.g. 91% or higher.

The dried highly digestible material obtained from the method according to the present invention may be in the form of particles of which more than about 99% (w/w) may be smaller than a few mm, like for example smaller than about 2 mm. Furthermore, more than about 95% (w/w) of the particles may be larger than about 8 μm. This, combination of particles according to the present invention may provide a free flowing powder that can easily be handled and further processed into for example formulated pet foods animal feeds, and/or fish feed.

In a preferred embodiment the average particle size (defined as d50; 50% of the volume fraction of the particles is larger, and 50% is smaller), measured by laser diffraction on a Beckman Coulter particle size analyser using standard software, may be between about 20 μm and about 0.7 mm, such as between about 20 μm and about 500 μm, e.g. between about 50 μm and about 300 μm, such as between about 75 and about 150 μm.

In an embodiment of the present invention the d90 may be below about 1 mm, such as below about 0.7 mm.

In yet an embodiment of the present invention the d10 may be above about 10 μm, such as above about 15 μm.

The particle size distribution of the partially hydrolysed keratinaceous material of the present invention may be relatively homogeneous. For example, the d90 divided by the d10 may be about 20 or less, such as about 15 or less, while the d90 may be about 1 mm or lower.

A preferred embodiment of the present invention relates to a system comprising a hydrolyser in fluid connection to a pre-treating unit which is in fluid connection with a spin flash dryer.

A further preferred embodiment of the present invention relates to a system comprising a hydrolyser in fluid connection to an oil or fat removing device, such as a press, a decanter (such as a two-phase decanter or a tri-phase decanter), which oil or fat removing device is in fluid connection to a contact dryer, such as a disc dryer, which contact dryer is in fluid connection with an air dryer, such as a spin flash dryer.

An even further preferred embodiment of the present invention relates to a system comprising a hydrolyser in fluid connection to an oil or fat removing device, which oil or fat removing device is in fluid connection to an air dryer, such as a spin flash dryer.

The system according to the present invention may relate to a process plant or part of a process plant including the relevant units.

In an embodiment of the present invention the pre-treating unit may comprise a pre-dryer. Preferably the pre-dryer may be a disc dryer.

Preferably, the system according to the present invention may be a rendering system for converting waste animal tissue into stable, usable materials, in particular stable, usable proteins.

Preferably, the rendering system may be suitable for converting waste animal tissue, such as keratinaceous starting materials, in particular feathers.

In an embodiment of the present invention the system may comprise a screw press or a twin-screw press to provide an initial reduction in moisture content by pressing the hydrolyzed material. The pressing may result in a press cake, comprising most of the solid part and a press liquid comprising some solids but being rich in moisture.

In an embodiment of the present invention the system may comprise an oil or fat removing device. Preferably the oil or fat removing device may be a press (such as a screw press), a decanter (such as a two-phase decanter or a tri-phase decanter).

The oil or fat removing device may be in fluid connection with the hydrolyser in one end (preferably the inlet of the oil or fat removing device) and with the pre-dryer in the other end (preferably the outlet of the oil or fat removing device).

In another embodiment of the present invention the oil or fat removing device may be in fluid connection with the pre-dryer in one end (preferably the outlet of the oil or fat removing device) and with an air drying process in the other end (preferably the outlet of the oil or fat removing device)

A preferred embodiment of the present invention relates to the use of a pre-drying process followed by a spin flash drying process of a hydrolysed material for providing a dried highly digestible material, preferably the dried highly digestible material comprises a pepsin digestibility higher than 75%.

The following methods may be used as suitable methods to measure the parameters stated in the description and the claims:

Weight percentage (% (w/w)) moisture: moist material may be dried overnight in a vacuum stove at reduced pressure and with a siccative. The material is weighed before and after the drying step, and the amount of moisture is calculated using the initial measured weight as 100% while assuming that all the volatile material is water.

Pepsin digestibility is measured according to ISO 6655 (August 1997) using as per the said mentioned norm a pepsin concentration of 0.02% in hydrochloric acid.

Particle size distribution has been measured with laser diffraction; on a Beckman Coulter particle size analyser-dry powder system. Standard software of the manufacturer was used. The results are described as d10, d50, d90 etc., which relates to the volume fractions.

In an embodiment the method (and/or the system) of the present invention may be capable of processing more than 3 tons/hour, such as 4 tons/hour or more, e.g. 5 tons/hour or more, such as 7 tons/hour or more, e.g. 10 tons/hour or more, such as 12 tons/hour or more, e.g. 15 tons/hour or more.

It should be noted that embodiments and features described in the context of one of the aspects or one embodiment of the present invention also apply to the other aspects or other embodiments of the invention.

All patent and non-patent references cited in the present application, are hereby incorporated by reference in their entirety.

The invention will now be described in further details in the following non-limiting examples.

### EXAMPLES

### Example 1

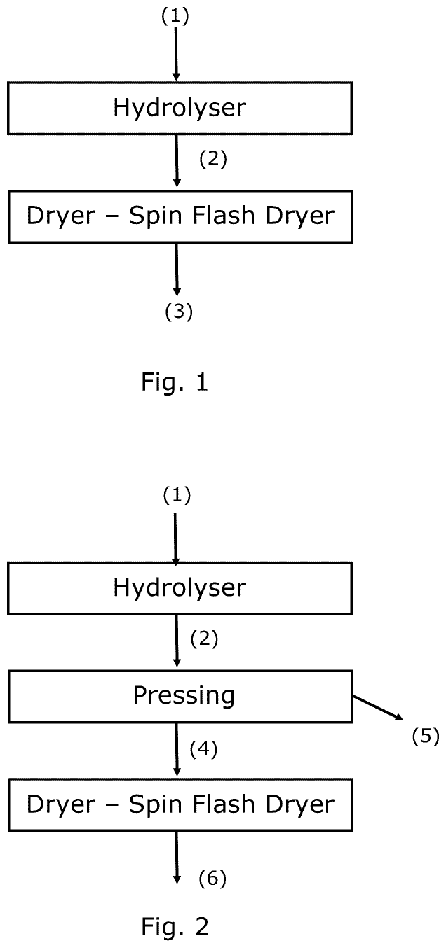

In a continuous horizontal hydrolyser, working at 5 bar and saturated steam in the reaction chamber, 10 ton/hour feathers from chicken and the feathers comprises (marked with reference (1) in FIGS. 1-3):
a moisture content of 65% (w/w)—resulting in 6500 kg/hour,
a solid content of 32% (w/w)—resulting in 3200 kg/hour, and
a fat content of 3% (w/w)—resulting in 300 kg/hour,

The feathers were treated in the hydrolyser for 25 min with about 200 gram steam per kg of keratinaceous material.

The hydrolysed feathers were brought to atmospheric pressure through a let-down valve allowing moisture to flash off, and the fibrous mass contained about 58% (w/w) moisture, while being at a temperature of 95° C. the hydrolysed feathers have the following composition (marked with reference (2) in FIGS. 1-3):
a moisture content of 58% (w/w)—resulting in 4833 kg/hour,
a solid content of 38.4% (w/w)—resulting in 3200 kg/hour, and
a fat content of 3.6% (w/w)—resulting in 300 kg/hour,

The hydrolysed feathers were divided into 3 fractions which were subjected to 3 different treatments:

### The First Fraction

The first fraction was subjected to drying in a spin flash dryer supplied by Haarslev, directly from the hydrolyser, following the process described in FIG. 1. The product feed was about 2777 kg/hour, while the amount of air was about 35,000 m³/hour and the inlet gas (air) at a temperature of 150° C.

The dry highly digestible hydrolysed feathers have the following composition (marked with reference (3) in FIG. 1):
a moisture content of 6% (w/w)—resulting in 75 kg/hour,
a solid content of 86% (w/w)—resulting in 1067 kg/hour, and
a fat content of 8% (w/w)—resulting in 100 kg/hour,
a steam flow of 0 kg/hour of wet hydrolysed feathers
an energy consumption of 216 Nm³/hour

The total amount of energy used for drying with the first fraction was 216 Nm³/hour and the total amount of steam used was 0 kg/hour and the total amount of air used was 35,000 m³/hour.

The digestibility of the dry highly digestible hydrolysed feathers obtained from the first fraction was about 85%.

The second fraction

After the hydrolyser, the second fraction was pressed in a screw press providing a press cake and a press liquid.

The press cake has the following composition (marked with reference (4) in FIG. 2):
a moisture content of 45% (w/w)—resulting in 841 kg/hour,
a solid content of 50,4% (w/w)—resulting in 943.5 kg/hour, and
a fat content of 4,6% (w/w)—resulting in 85 kg/hour,

The press liquid has the following composition (marked with reference (5) in FIG. 2):
a moisture content of 84,8% (w/w)—resulting in 770 kg/hour,
a solid content of 13,6% (w/w)—resulting in 123.6 kg/hour, and
a fat content of 1.6% (w/w)—resulting in 14.6 kg/hour,

Following pressing, the press cake was subjected to drying in a spin flash dryer supplied by Haarslev. The product feed was about 1869.5 kg/hour, while the amount of air was about 15.000 m³/hour and the inlet gas (air) at a temperature of 150° C.

The dry highly digestible hydrolysed feathers have the following composition (marked with reference (6) in FIG. 2):
a moisture content of 6% (w/w)—resulting in 65.6 kg/hour,
a solid content of 86,2% (w/w)—resulting in 943 kg/hour, and
a fat content of 7,8% (w/w)—resulting in 85 kg/hour,
a steam flow of 0 kg/hour
an energy consumption of 94.5 Nm³/hour

The total amount of energy used with the second fraction was 94.5 Nm³/hour and the total amount of steam used was 0 kg/hour and the total amount of air used was 15.000 m³/hour.

The digestibility of the dry highly digestible hydrolysed feathers obtained from the second fraction was about 85%.

The third fraction After the hydrolyser, the third fraction was subjected to a pre-drying in a disc dryer operating with atmospheric drying conditions at 1 bar absolute corresponding to about 100° C.

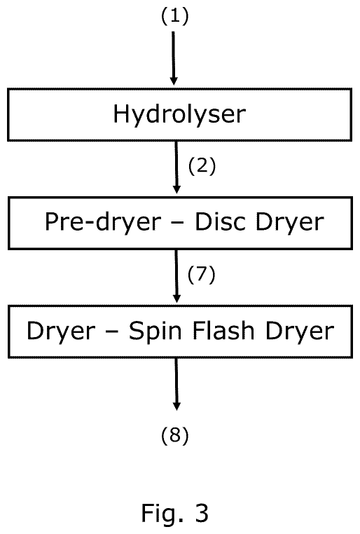

The pre-dried hydrolysed feathers have the following composition (marked with reference (7) in FIG. 3):
a moisture content of 35% (w/w)—resulting in 628 kg/hour,
a solid content of 38.4% (w/w)—resulting in 1066.6 kg/hour,
a fat content of 3.6% (w/w)—resulting in 100 kg/hour, and
a steam flow of 775 kg/hour.

Following pre-drying, the pre-dried hydrolysed feathers were subjected to drying in a spin flash dryer supplied by Haarslev. The product feed was about 1795 kg/hour, while the amount of air was about 12.000 m³/hour and the inlet gas (air) at a temperature of 150° C.

The dry highly digestible hydrolysed feathers have the following composition (marked with reference (8) in FIG. 3):
a moisture content of 6% (w/w)—resulting in 74.3 kg/hour,
a solid content of 85.9% (w/w)—resulting in 1066.6 kg/hour,
a fat content of 8.1% (w/w)—resulting in 100 kg/hour,
a steam flow of 775 kg/hour, and
an energy consumption of 75 Nm³/hour.

The amount of energy used with the third fraction was 75 Nm³/hour and the amount of steam used was 775 kg/hour and the total amount of air used was 12.000 m³/hour.

The digestibility of the dry highly digestible hydrolysed feathers obtained from the second fraction was about 88%.

### Conclusion

As shown with the experiments with the 3 fractions the larger volumes may be processed faster with the process of fraction 3 and the energy consumption and air consumption are reduced making the process using pre-treatment, like pre-drying, much more favourable and a better investment for the producer.

Surprisingly the pepsin digestibility of the third fraction was also improved relative to the two other fraction. Without being bound by theory it is believed that this is caused by maintaining the stick water in the fraction and the more gentle combination of drying where the effect of the spin flash drying, and thus the exposure of the pre-dried hydrolysed material to high temperatures are reduced.

### Example 2

In a continuous horizontal hydrolyser, working at 5 bar and saturated steam in the reaction chamber, 10 ton/hour feathers from chicken and the feathers comprises:
a moisture content of 58.4% (w/w)—resulting in 5840 kg/hour,
a solid content of 34.6% (w/w)—resulting in 3460 kg/hour, and
a fat content of 7% (w/w)—resulting in 700 kg/hour,

The feathers were treated in the hydrolyser for 25 min with about 200 gram steam per kg of feathers.

The hydrolysed feathers were brought to atmospheric pressure through a let-down valve allowing moisture to flash off, and the fibrous mass contained about 58% (w/w) moisture, while being at a temperature of 95° C.

The hydrolysed feathers have the following composition:
a moisture content of 57.9% (w/w)—resulting in 5721 kg/hour,
a solid content of 35% (w/w)—resulting in 3460 kg/hour, and
a fat content of 7.1% (w/w)—resulting in 700 kg/hour,

The hydrolysed feathers were subjected to drying in a spin flash dryer supplied by Haarslev, directly from the hydrolyser.

The dry highly digestible hydrolysed feathers have the following composition:
a moisture content of 7.8% (w/w)—resulting in 350 kg/hour,
a solid content of 76.7% (w/w)—resulting in 3460 kg/hour, and
a fat content of 15.5% (w/w)—resulting in 700 kg/hour,

The digestibility of the dry highly digestible hydrolysed feathers obtained from the first fraction was about 82%.

### Example 3

In a continuous horizontal hydrolyser, working at 5 bar and saturated steam in the reaction chamber, 10 ton/hour feathers from chicken and the feathers comprises:
a moisture content of 58.4% (w/w)—resulting in 5840 kg/hour,
a solid content of 34.6% (w/w)—resulting in 3460 kg/hour, and
a fat content of 7% (w/w)—resulting in 700 kg/hour,

The feathers were treated in the hydrolyser for 25 min with about 200 gram steam per kg of feathers.

The hydrolysed feathers were brought to atmospheric pressure through a let-down valve allowing moisture to flash off, and the fibrous mass contained about 58% (w/w) moisture, while being at a temperature of 95° C.

The hydrolysed feathers have the following composition:
a moisture content of 57.9% (w/w)—resulting in 5721 kg/hour,
a solid content of 35% (w/w)—resulting in 3460 kg/hour, and
a fat content of 7.1% (w/w)—resulting in 700 kg/hour,

After the hydrolyser, the hydrolysed feathers were pressed in a twin-screw press providing a press cake and a press liquid.

The press cake has the following composition:
a moisture content of 39.4% (w/w)—resulting in 1927 kg/hour,
a solid content of 57% (w/w)—resulting in 2788 kg/hour, and
a fat content of 3,6% (w/w)—resulting in 178 kg/hour.

The press liquid has the following composition (marked with reference (5) in FIG. 2):
a moisture content of 76.1% (w/w)—resulting in 3794 kg/hour,
a solid content of 13,5% (w/w)—resulting in 672 kg/hour, and
a fat content of 10.5% (w/w)—resulting in 522 kg/hour.

The press liquid may be subjected to separation (3-phase separation) using a three-phase decanter (e.g. a tricanter) providing a fat phase, a water phase and a solid phase.

The fat phase has the following composition:
a moisture content of 0.14% (w/w)—resulting in 0.7 kg/hour,
a solid content of 0.34% (w/w)—resulting in 1.7 kg/hour, and
a fat content of 99.52% (w/w)—resulting in 497 kg/hour.

The solid phase has the following composition:
a moisture content of 62.4% (w/w)—resulting in 713 kg/hour,
a solid content of 36,3% (w/w)—resulting in 414 kg/hour, and
a fat content of 1.3% (w/w)—resulting in 15 kg/hour.

The water phase has the following composition:
a moisture content of 92% (w/w)—resulting in 3081 kg/hour,
a solid content of 7.7% (w/w)—resulting in 258 kg/hour, and
a fat content of 0.3% (w/w)—resulting in 10 kg/hour.

The fat phase was discarded and the press cake was mixed with the solid phase obtained from the three-phase decanter and with the water phase of the three-phase decanter providing a combined press cake.

The combined press cake has the following composition:
a moisture content of 61% (w/w)—resulting in 5721 kg/hour,
a solid content of 36.9% (w/w)—resulting in 3460 kg/hour, and
a fat content of 2.1% (w/w)—resulting in 203 kg/hour.

The combined press cake was subjected to drying in a spin flash dryer supplied by Haarslev, directly from the hydrolyser.

The dry highly digestible hydrolysed feathers have the following composition:
a moisture content of 8% (w/w)—resulting in 325 kg/hour,
a solid content of 87% (w/w)—resulting in 3460 kg/hour, and
a fat content of 5% (w/w)—resulting in 203 kg/hour,

The digestibility of the dry highly digestible hydrolysed feathers obtained from the first fraction was about 86%.

### Conclusion

As the fat content above 10%, or even above 8% in the final dried product may be undesirable, it may be preferred to introduce a fat removal step before subjecting the material to drying. At the same time it may be desirable to limit the loss of product/solids from the final product. Therefore, separating the fat phase (having very low content of solids) and recycling the solid phase and optionally the liquid phase obtained from the separation process, may be desirably. The liquid phase may comprise some solids that may be desirable to include in the product. Alternatively, the liquid phase may also be removed from the process, which would reduce the amount of water in the combined press cake and thus also reduce the energy consumption for drying the powder. The liquid phase may also be concentrated before being recycled into the press cake.

The energy consumption for producing the feather meal may be reduced by reducing the moisture content of the hydrolysed products to be dried as demonstrated in example 1. This moisture reduction may be provided by introducing a pre-drying step of the press cake or the combined press cake, as described herein; or by concentrating the water part and/or the solid part obtained from the separation (the three-phase decanter); or by discarding the water part from the process; or the like.

Surprisingly the pepsin digestibility of the powder produced in example 3 (with a reduced fat content) was also higher than the powder produced in example 2 (without the fat removal step).

Without being bound by theory it is believed that this is caused by reducing the fat content from the stick water but still returning the relevant fractions to the final product.

### REFERENCES

EP 3 402 340 A1
U.S. Pat. No. 4,747,550
WO1995/028512
WO2015/136070

1. A method for providing a dry highly digestible material from a starting material, the method comprising:
hydrolysing the starting material, providing a hydrolysed material;
subjecting the hydrolysed material to a fat removal process, providing a fat-reduced material; and
subjecting the fat-reduced material to an air drying process resulting in a dried highly digestible material.

2. The method according to claim 1, wherein the hydrolysed material or the fat-reduced material is subjected to a pre-treatment where water, or at least part of the water, in the hydrolysed material is at least vapourised resulting in a pre-dried hydrolysed material.

3. The method according to claim 2, wherein the pre-dried hydrolysed material has a moisture content in the range of 15-50% (w/w) water.

4. A method for providing a dry highly digestible material from a starting material, the method comprising:
hydrolysing the starting material, providing a hydrolysed material;
subjecting the hydrolysed material to a pre-treatment where water in the hydrolysed material is at least vapourised resulting in a pre-dried hydrolysed material, wherein the pre-dried hydrolysed material has a moisture content in the range of 15-50% (w/w) water; and
subjecting the pre-dried hydrolysed material to a drying process resulting in a dried highly digestible material
wherein the hydrolysed material is subjected to a fat-removal process and/or wherein the pre-dried hydrolysed material is subjected to a fat-removal process.

5. The method according to claim 4, wherein the drying process is an air-drying process.

6. The method according to claim 1, wherein the air-drying process is a spin flash drying process.

7. The method according to claim 1, wherein the starting material is selected from a keratinaceous material.

8. The method according to claim 1, wherein the pre-treatment of the hydrolysed material is a pre-drying of the hydrolysed material.

9. The method according to claim 8, wherein the pre-drying of the hydrolysed material may be performed by a contact dryer.

10. The method according to claim 9, wherein the contact dryer is a disc dryer.

11. The method according to claim 8, wherein the pre-dried hydrolysed material may have a moisture content in the range of 20-45% (w/w), e.g. in the range of 25-43% (w/w), such as in the range of 30-40% (w/w), e.g. in the range of 32-38% (w/w), such as about 35% (w/w).

12. A dried highly digestible material obtained by the method according to claim 1.

13. A dried highly digestible material comprising a crude protein content in the range of 80-97% (w/w), a fat content in the range of 0.01-8% (w/w), and below 10% (w/w) water.

14. The dried highly digestible material according to claim 13, wherein the dried highly digestible material comprises a pepsin digestibility higher than 75%, such as higher than 80%, e.g. higher than 85%, such as 86% or higher, e.g. 87% or higher, such as 88% or higher, e.g. 89% or higher, such as 90% or higher, e.g. 91% or higher, such as 92% or higher, e.g. 93% or higher and/or wherein the dried highly digestible material comprises an average particle size when measured as d50 in volume fraction, as measured with laser diffraction using a dry powder Beckman Coulter particle size analyser, between about 20 μm and about 0.7 mm and the d90 below about 1 mm.

15. A system comprising a hydrolyser in fluid connection to an oil or fat removing device, such as a press, a decanter, which oil or fat removing device is in fluid connection to a contact dryer, such as a disc dryer, which contact dryer is in fluid connection with an air dryer, such as a spin flash dryer.
